(19) United States
(12) Patent Application Publication
(10) Pub. No.: US 2007/0035854 A1
(43) Pub. Date: Feb. 15, 2007

(54) Adjustable optical assembly

(75) Inventors: Christian Haefele, Feldkirch (AT); Roman Steffen, Rebstein (CH)

Correspondence Address: ABELMAN, FRAYNE & SCHWAB, 666 THIRD AVENUE, 10TH FLOOR, NEW YORK, NY, 10017, US

(73) Assignee: HILTI AKTIENGESELLSCHAFT

(21) Appl. No.: 11/501,989

(22) Filed: Aug. 9, 2006

(30) Foreign Application Priority Data
Aug. 9, 2005 (DE) 10 2005 037 631.2

(51) Int. Cl. G02B 7/02

(52) U.S. Cl. 359/811

(57) ABSTRACT

An optical assembly, which is adjustable relative to an axis (A), includes an optics carrier (1), at least two optical components (2, 3) fixedly connected with the optics carrier (1) and axially spaced from each other, and at least one thin, partially tangentially oriented, deformation web (4) provided in the optics carrier (1) in an axial intermediate region (X) between the at least two optical components (2, 3)

### BACKGROUND OF THE INVENTION

1. Field of the Invention

The present invention relates to an adjustable optical assembly and, in particular to collimator optics for laser diodes which is capable of being brought into focus.

2. Description of the Prior Art

Laser diodes require additional collimator optics for parallel orientation of the laser beam. With the collimator optics, after mounting of the laser diode and the collimator lens in an optics carrier, an adjustment of opposite positions relative to each other, which includes axial displacement (focus) and inclination, should be effected. With simple collimator optics, the laser diodes and the collimator lens are secured only after the adjustment has been made. The securing process, e.g., gluing, require some time which represents a drawback at mass production.

According to German utility model DE 9002698U, with collimator optics, centering of the laser diode takes place. The laser diode is axially secured in a housing with a retaining part and is adjusted in the XY-plane with adjusting elements which cooperate with the circumference of a centering ring. The collimator optics, which as to be readjusted each time, has many components.

U.S. Pat. No. 6,657,788 discloses an adjustable optical assembly including collimator optics and a prism between which thin, axially oriented, deformable webs are provided. The deformable webs form, in a cylindrical sleeve that serves as an optics carrier, circumferentially offset holes through which selective rays, which are reflected by the prism, exit. The adjustment of the collimator optics is not effected with the plastically deformable deformation webs.

The object of the invention is to provide an adjustable optical assembly with a large adjustment range that can be easily adjusted and is suitable for mass production.

### SUMMARY OF THE INVENTION

This and other objects of the present invention, which will become apparent hereinafter, are achieved by providing an optical assembly adjustable relative to an axis and including an optics carrier, at least two optical components fixedly connected with the optics carrier and axially spaced from each other, and at least one thin, partially tangentially oriented, deformation web provided in the optics carrier in an axial intermediate region between the two optical components.

With a tangentionally oriented deformation webs in comparison with axial deformation webs, a relatively large displacement can be achieved already with a small shear deformation, which provides for a greater adjustment range.

Advantageously, the optics carrier is formed essentially as a sleeve-shaped (hollow cylindrical or hollow prismatic) body, whereby correspondingly formed assembly components can be coaxially arranged in the interior of the carrier. In addition, this shape of the optics carrier provides for an axial symmetry.

Advantageously, there is provided a plurality of tangentially oriented, distributed about the axis, deformation webs, whereby the flexural inertia component of the optics carrier in the intermediate region is increased.

Advantageously, the tangentially oriented deformation webs form a circumferential deformation ring, whereby tangential normal stresses are compensated by hoop stresses.

Advantageously, there are provided at least three, circumferentially offset relative to each other, supports on each of opposite axial sides of the deformation ring for connecting the deformation ring with the optics carrier. Thereby, the flexural inertia component of the optics carrier on the edge of the intermediate region increases.

Advantageously, there are provided six supports circumferentially offset relative to each other by 60°, which form, on each of the opposite axial sides, a group of three supports circumferentially offset relative to each other by 120°. Thereby, the shear-deformable tangential length is maximized.

Advantageously, the optics carrier is formed of a highly elastic material such as, e.g., an available die cast zinc with hexagonal cristal structure. This material insures large deformations in the region of elasticity in comparison with other materials and, thus, is reversible.

Advantageously, there are provided at least three adjusting elements which extend over the axial intermediate region (wedges, screws, threaded pins, balls, etc.) advantageously in form of wedges. Thereby, the elasticity of the intermediate region and the static friction make a reversible and, at the same time, stable adjustment of the optical assembly possible.

Alternatively, the optics carrier can be formed of a highly plastic material such as, e.g., die cast copper available with a face-centered cubic cristal structure. This material insures, in comparison with other materials, that at plastic deformation, only small spring back recovery takes place, which make the deformation irreversible.

Advantageously, the assembly is an adjustable collimator optics capable of being brought into focus, and including, a laser diode and a collimator lens. This permits to realize an adjustable, capable of being focused, beam source suitable for mass production.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a side view of an optical assembly according to the present invention; and

FIG. 2 a cross-sectional view along line II-II in FIG. 1.

### DETAILED DESCRIPTION OF THE PREFERRED EMBODIMENTS

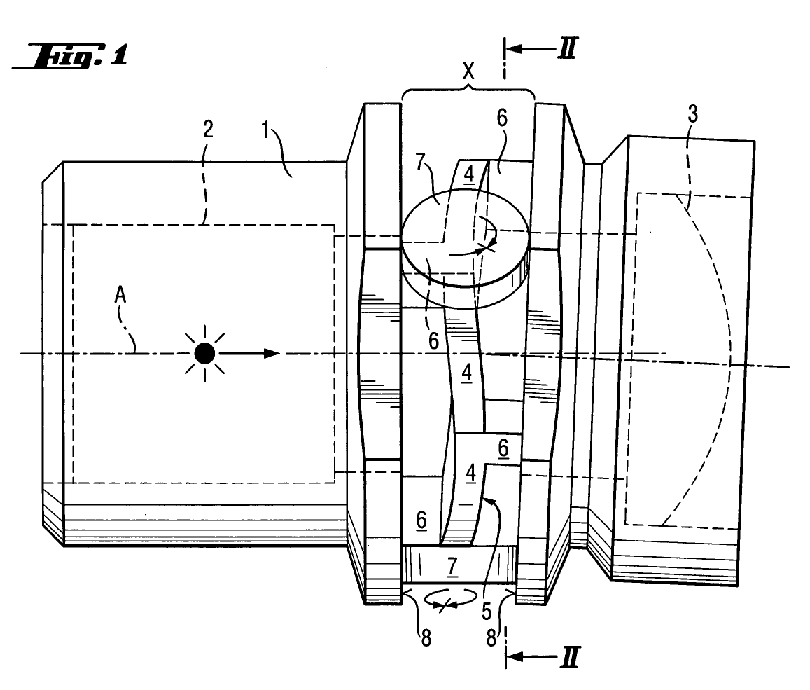

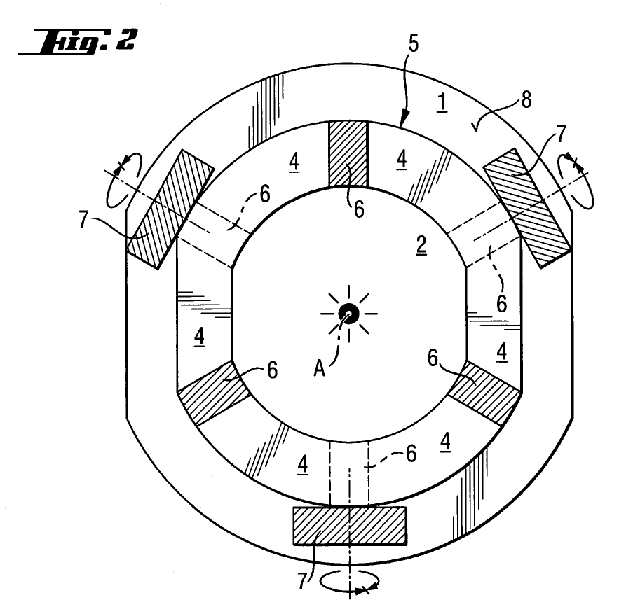

FIGS. 1 and 2 show an optical assembly according to the present invention the inclination of which relative to an axis A is adjustable. The inventive optical assembly is formed as a collimator optics that is capable of being brought into focus, and has a metal optics carrier 1. In the interior of the optics carrier 1, there are located, coaxially therewith, two optical components in form of a laser diode 2 and a collimator lens 3 which are fixedly connected with the optics carrier 1. The optics carrier 1 has, in its axial intermediate region between the two optical components, a plurality of thin, tangentially oriented deformation webs 4 which form together a circumferential deformation ring 5. The circumferential deformation ring 5 is connected with the optics carrier 1 by circumferentially arranged supports 6.

On each of the opposite sides of the deformation ring (5) there are arranged three supports 6 offset relative to each other by 120°. The supports 6 on the rear side of the optics carrier 1 were shown with dash lines. In addition, there are provided three, circumferentially arranged, adjusting elements 7 which are offset relative to each other by 120° and extend axially over the intermediate region X. The adjusting elements 7 are formed as non-circular rotary wedges which are frictionally preloaded against axial surfaces 8 on the optics carrier 1.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. An optical assembly adjustable relative to an axis (A), comprising an optics carrier (1); at least two optical components (2, 3) fixedly connected with the optics carrier (1) and axially spaced from each other; and at least one thin, partially tangentially oriented, deformation web (4) provided in the optics carrier (1) in an axial intermediate region (X) between the at least two optical components (2, 3).

2. An optical assembly according to claim 1, wherein the optics carrier (1) is formed as a sleeve-shaped part.

3. An optical assembly according to claim 1, comprising a plurality of thin, at least partially tangentially oriented, deformation webs (4) provided in the axial intermediate region of the optics carrier (1) and circumferentially distributed about the axis (A).

4. An optical assembly according to claim 3, wherein the plurality of deformation webs (4) forms a circumferential deformation ring (5).

5. An optical assembly according to claim 4, further comprising at least three, circumferentially offset relative to each other, supports (6) on each of opposite axial sides of the deformation ring (5) for connecting the deformation ring (5) with the optics carrier (1).

6. An optical assembly according to claim 5, comprising only six supports (6) circumferentially offset relative to each other by 60°, forming on each of the opposite axial sides a group of three supports (6) circumferentially offset relative to each other by 120°.

7. An optical assembly according to claim 1, wherein the optics carrier (1) is formed of a highly elastic material.

8. An optical assembly according to claim 7, comprising at least three adjusting elements (7) extending over the axial intermediate region (X) of the optics carrier (3).

9. An optical assembly according to claim 1, wherein the optics carrier (1) is formed of a highly plastic material.

10. An optical assembly according to claim 1, wherein the assembly is an adjustable collimator optics capable of being brought into focus, and wherein the at least two optical components (2, 3) are a laser diode (2) and a collimator lens (3).
